(19) United States
(12) Patent Application Publication
(10) Pub. No.: US 2006/0196540 A1
(43) Pub. Date: Sep. 7, 2006

(54) Catastrophic release control valve apparatus and method

(76) Inventor: John H. Winters, Houston, TX (US)

Correspondence Address: THE MATTHEWS FIRM, 2000 BERING DRIVE, SUITE 700, HOUSTON, TX, 77057, US

(21) Appl. No.: 11/072,901

(22) Filed: Mar. 4, 2005

(51) Int. Cl. G05D 7/01

(52) U.S. Cl. 137/110

(57) ABSTRACT

A fluid flow inhibitor for use with increased fluid flow. The fluid flow inhibitor has a fluid tubular which contains a chamber with at least one fluid plug and at least one fluid barrier with an aperture or orifice. When increased fluid flows through the system, the fluid plug or plugs move to block the flow of fluid through the orifice(s) or aperture(s) thereby reducing or eliminating fluid flowing through the system. When the fluid flow rate returns to normal flow rate, the fluid plug(s) resume their standby position and fluid flows through the orifice or aperture at a normal rate.

### TECHNICAL FIELD

The present invention relates generally to apparatus and methods used to restrict the flow of a fluid, gas or plasma through a fluid, gas, granulated solid, semi-solid or plasma containment tubular.

### BACKGROUND ART

It has become imperative, in recent times, to quickly and safely prevent the catastrophic release of dangerous liquids, gases, granulated solid, semi-solids and plasmas (hereinafter known as “fluids”) into the environment and atmosphere. There are several methods to prevent the flow of fluids through a fluid tubular or channel, but none are as efficient or cost effective as the present invention.

In the previous art, typically, pressure sensitive valves function to either impede the flow of a pressurized fluid or allow for the discharge of a pressurized fluid from a vessel. Most prior art valves involve mechanisms with multiple internal working parts or parts that upon activation require replacement prior to future use and/or require an operator interface. Since these valves require maintenance, frequent actual replacement, or computer control, their use can increase downtime needed for repair or replacement on many fluid flow applications.

The present invention alleviates these problems by having internally contained and predetermined flow rate control mechanisms that do not involve complicated moving parts or replacement upon each use and are intrinsic and inherent in the invention itself because the invention is created with these control mechanisms already present and internal to the invention. The present invention involves the use of a fluid tubular or body through which a fluid can flow. The invention activates when there is an event that would cause the liquids, gases, granulated solid, semi-solids and plasmas to exceed the pre-determined fluid flow rate for which the tubular or body is crafted or machined. Due to the laminar effect, a flow control plug located inside the tubular or body will wedge in the control orifice, also located in the tubular, until the fluid flow rate is instantly restricted or impeded responsive to a pre-determined flow rate. The viscosity and specific gravity of flow material coupled with the actual flow rate motivate the flow plug. When the fluid flow is reduced, the flow control plug is no longer held against the control orifice. Dependent upon the fluid material and temperatures being controlled, the design of the invention is constructed based upon the construction materials being compatible with those fluid materials being controlled to ensure that there is no internal corrosion, chemical or thermal interactions between the construction and fluid materials.

### BRIEF DESCRIPTION OF DRAWINGS

FIG. 1a illustrates a schematic view, partially in cross section, of the present invention with one fluid plug element present in the inactive position.

FIG. 1b illustrates a schematic view, partially in cross section, of the present invention with multiple fluid plug elements present in the inactive position.

FIG. 1c illustrates a schematic view, partially in cross section, of the present invention with one fluid plug element present in the active position

FIG. 1d illustrates a schematic view, partially in cross section, of the present invention with multiple fluid plug elements present in the active position.

FIG. 2a-2f illustrate six configurations for the fluid intake/output apertures of the invention.

FIGS. 3a and 3b illustrate multiple configurations for the apertures on the chamber wall or fluid barrier of the invention.

FIG. 4 illustrates a schematic view, partially in cross section, of the present invention with a fluid plug element present in the inactive position as attached in the interior of a fluid containment vessel.

FIG. 5 illustrates a schematic view, partially in cross section, of two configurations of the present invention in tandem or in series with a fluid plug element present.

FIG. 6a illustrates a schematic view, partially in cross section, of the present invention with two fluid barrier elements present and the plug in the inactive position.

FIG. 6b illustrates a schematic view, partially in cross section, of the present invention with two fluid barrier elements present with the plug in the active position.

FIG. 6c illustrates a schematic view, partially in cross section, of the present invention with two fluid barrier elements present with an alternative active fluid plug position.

The above mentioned and other objects and advantages of the present invention, and a better understanding of the principles and details of the present invention, will be evident from the following description taken in conjunction with the appended drawings.

The drawings constitute a part of this specification and include exemplary embodiments of the present invention, which may be embodied in various forms. It is to be understood that in some instances, various aspects of the invention may be shown exaggerated, reduced or enlarged, or otherwise distorted to facilitate an understanding of the present invention.

For a further understanding of the nature and objects of the present invention, reference should be had to the following detailed description, taken in conjunction with the accompanying drawings, in which like elements are given the same or analogous reference numbers.

### GENERAL DESCRIPTION AND PREFERRED MODE FOR CARRYING OUT THE INVENTION

For a further understanding of the nature, function, and objects of the present invention, reference should now be made to the following detailed description taken in conjunction with the accompanying drawings. Detailed descriptions of the embodiments are provided herein, as well as, a mode of carrying out and employing embodiments of the present invention. It is to be understood, however, that the present invention may be embodied in various forms other than those specifically disclosed. Therefore, specific details disclosed herein are not to be interpreted as limiting, but rather as a basis for the claims and as a representative basis for teaching one skilled in the art to employ the present invention in virtually any appropriately detailed system, structure, or manner. The practice of the present invention is illustrated by the following examples which are deemed illustrative of both the process taught by the present invention and of the product and article of manufacture made in accordance with the present invention. It should be understood that “fluid” as defined throughout this patent is to include, but not be limited to, any liquid, gas, plasma, semi-solids, granulated solids or any combination of those components. It is important to note that several embodiments of the invention can be used in a liquid fuel environment and on pipe lines.

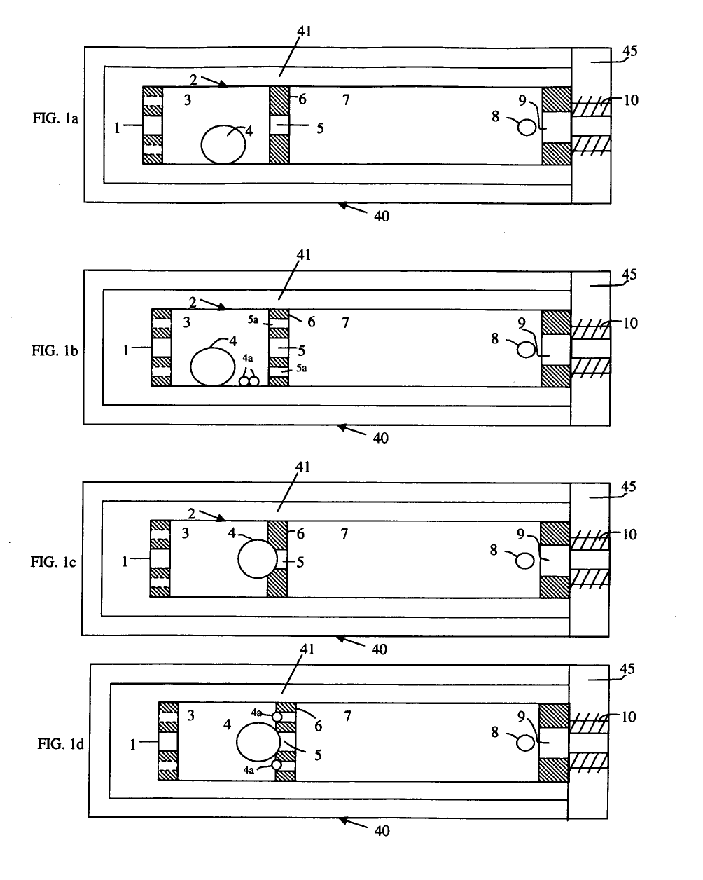

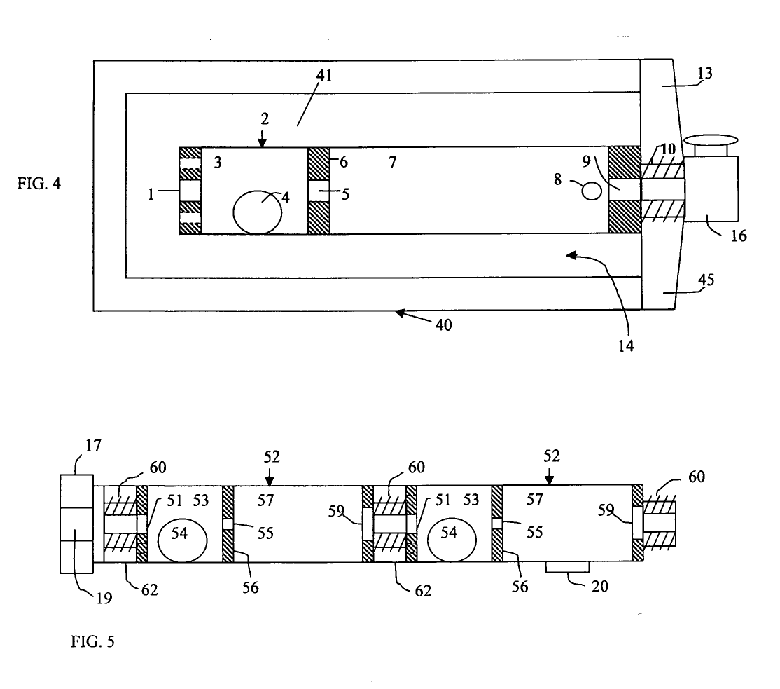

FIG. 1a illustrates one embodiment of the present invention. The fluid tubular 2 includes a fluid intake port 1 and a fluid outflow port 9. The fluid tubular is housed in a fluid container 40, such that the fluid tubular 2 is surrounded by fluid 41 housed internal to the fluid container 40. It is important to note that fluid could flow in either direction through the fluid tubular 2, dependent on the fluid pressures external to both fluid intake port 1 and fluid outflow port 9. For example, fluid container 40 could be filled up with fluid under pressure external to the container in which the fluid would then flow into the fluid outflow port 9 instead of out of it, such as when loading the fluid container 40. Fluid intake/outflow port 1 is a standard fluid intake/outflow port used in the industry and can be fitted with one or a plurality of fluid intake/outflow apertures. The end barrier surrounding fluid intake port 1 is preferably composed of, but not limited to, plastic, wire mesh, ceramics or metal, or combinations thereof. The end barrier surrounding fluid intake port 1 aperture can assume any shape provided that it forms a ported barrier internal and is disposed about fluid tubular 2. Fluid intake/outflow port 1 is the port into which fluid 41 will typically flow from the fluid chamber 40 into the fluid tubular 2. Anterior chamber 3 is spaced between fluid intake/outflow port 1 and chamber wall or fluid barrier 6, and forms a semi-enclosed interior chamber in fluid tubular 2. Chamber wall or fluid barrier 6 consists of any barrier capable of impeding the flow of fluid if blocked either partially or fully. Anterior chamber 3 houses the fluid plug 4, which may be but is not limited to any polyhexagonal or spheroidal shape. Fluid plug 4 is nonchemically reactive and non-corrosive relative to the fluid tubular 2 and the fluid flowing through fluid tubular 2. As an example if the fluid is ambient air or inert gas, a brass fluid plug 4 weighted to activate and move to impede the flow of the fluid at a specific flow rate and viscosity in one embodiment of the invention. Likewise, a stainless steel fluid plug 4 will work in most liquid fuel environments. Fluid plug 4 may be accompanied by one unit or a plurality of fluid plugs 4a of any polyhexagonal or spheroidal shape as is shown in FIGS. 1b and 1d. It is important to note that the smaller fluid plugs 4a are preferably composed of materials that are more dense than the material used in fluid plug 4, whereby it would take a greatly increased fluid flow to actuate the fluid plugs 4a thereby wedging into the apertures 5a, FIG. 1d. Fluid plug 4 is also calibrated for both density and size, such that fluid plug 4 is mobilized upon sufficient fluid 41 flow rate increase within fluid tubular 2. Chamber wall or fluid barrier 6 contains at least one fluid control orifice or aperture 5 through which fluid can flow out of anterior chamber 3. Flow through port 8, also referred to as a trought port, would allow normal delivery even when the fluid control orifice or aperture 5 is blocked by the fluid plug 4. Chamber wall or fluid barrier 6 can be of any desired thickness, shape or angle relative to the fluid tubular 2. The fluid control orifice or aperture 5 and fluid plug 4 are preferably molded so as to allow for fluid plug 4, and the plurality of fluid plugs 4a, (FIG. 1b) to be releasably inserted into fluid control orifice or aperture 5 and 5a respectively, upon activation due to increase in fluid flow, thereby forming a seal through which preferably fluid is impeded from flowing. The fluid flow can be partially impeded or fully impeded depending on the configuration of the invention, the shape of the plug 4, and the shape of the orifice 5. Fluid tubular 2 has a posterior chamber 7, which is located adjacent to chamber wall or fluid barrier 6, but does not contain a fluid plug 4. Posterior chamber 7 contains a calibrated thru flow port 8, which is designed to allow for the minimal pre-calibrated flow of fluid 41 into fluid tubular 2 and posterior chamber 7. Flow through port 8, is optional and acts as a bleeder valve to allow fluid 41 housed in the fluid chamber 40 to flow through the fluid tubular 2 at a much decreased rate over the predetermined fluid flow rate through inflow port 1. Posterior chamber 7 has a fluid intake/outflow port 9 located opposite to chamber wall or fluid barrier 6 which is of a standard configuration used in the industry and can have, but is not limited to one or a plurality of fluid flow apertures. Threadable adapter 10 is attached external to the fluid tubular 2 and adjacent to fluid intake/outflow port 9 and is of the standard size and configuration used in the industry pending on the application for which the invention is being utilized. Threadable adapter 10 is designed such that it can be attached internally to fluid vessel containment wall 13 (FIG. 4) and internally to a fluid container 40. The threadable adaptor 10 is hollow and designed to allow fluid to flow through it. The threadable adaptor 10 can be attached to the removable segment 45 of the outer wall of the fluid chamber 40 by being threaded into the back portion of the removable segment 45. The removable segment 45 can be attached or removed from the fluid container 40 in any manner that is conventional to the art, including but not limited to, being threadably attached, being adhered, or being soldered to the fluid container 40. It is important to note that one skilled in the art could conceive of a plurality of ways in which the removable segment 45 is attached to the fluid container 40 with the fluid tubular 2 being internal to the fluid container 40. It is important to note that fluid can flow into or out of fluid intake/outflow ports 1 and 9, respectively. Threadable adaptor 10 is of the type normally utilized in the industry to attach a tubular or object to the wall of a fluid containment tank and threadable adaptor 10 hollow so as to allow fluid to pass through it.

FIG. 1b is substantially similar to FIG. 1a with the exception that FIG. 1b illustrates a plurality of fluid plugs 4 and 4a which can be releasably inserted into fluid control orifices or apertures 5 and 5a, respectively, to form a seal with 5 or 5a, respectively, thereby impeding the flow of fluid through the invention. This impediment can be complete or only partial. In complete impediment, the fluid plugs 4 and 4a completely wedge into the fluid orifices 5 and 5a, respectively, therein forming a sealing barrier. In partial impediment the fluid plug 4 wedges into the orifice 5, by which the seal formed is not complete and fluid can flow through the orifice 5, but at a reduced volume and rate. The composition, size and shape of the plugs 4 and 4a are variable such that each plug 4 or 4a will be activated by a different change in fluid flow rate. Hence, plug 4 could be activated individually thereby impeding the flow of fluid through the fluid tubular 2, without completely stopping the flow of fluid through fluid tubular 2.

The invention works in, but is not limited to the following manner. FIGS. 1a and 1b illustrate that in normal fluid flow operation, the fluid flows into fluid tubular 2 through the apertures intake/outflow port 1 and enters into anterior chamber 3. The fluid will then pass through the chamber wall or fluid barrier 6 via its fluid control orifices or apertures 5 or 5a and into posterior chamber 7. Fluid 41 also flows into posterior chamber 7 from the fluid chamber 40 via the calibrated thru flow port 8. The fluid will then flow out of posterior chamber 7 via fluid intake/outflow port 9 and into whatever vessel, pump or valve it is attached to via threadable adapter 10. There is no impediment of fluid flow when the fluid is flowing through the invention at a normal pre-calibrated rate of flow. Fluid can be reloaded into the fluid chamber 40 by forcing fluid 41 in from fluid output port 9 into posterior chamber 7, through calibrated thru flow port 8 or chamber wall or fluid barrier 6 and then into anterior chamber 3. The fluid then flows out of fluid input port 1.

In one version of the aforementioned embodiment (FIGS. 1a and 1c) of the invention the outside diameter of the fluid tubular 2 is ¼ of an inch, whereas the interior diameter of the fluid tubular 2 is ⅛ of an inch. The fluid tubular 2, itself is manufactured of, but not limited to type 305 stainless steel. The fluid plug 4 is composed of a standard brass utilized in the industry and the plug is 3/32 of an inch in diameter weighing preferably 1/10 of a gram. The fluid control orifice or aperture 5 is preferably 1/32 of an inch in diameter. The calibrated maximum delivery rate of fluid for this embodiment through the barrier 6 is nine liters per minute and the fluid 41 for this embodiment is preferably ambient air. If the delivery rate through the fluid tubular 2 exceeds eighteen liters per minute then the fluid plug 4 will actuate and form a seal with the orifice or aperture 5, whereby the fluid will enter the through flow port 8 until the flow rate is below eighteen liters per minute. When the fluid 41 flow rate returns to a flow rate lower than eighteen liters per minute the fluid plug 4 will disengage the orifice 5 until such time as the flow rate again exceeds eighteen liters per minute. In an embodiment of the invention in which the through flow port 8 is missing, there is no fluid which can enter chamber 7 which does not pass through either orifice 5 or outflow port 9. It should be noted that one skilled in the art could readily calculate the specific gravities of plugs and fluid s along with variations of flow rates for alternate embodiments of the invention given the present disclosures.

FIGS. 1c and 1d are substantially similar to FIGS. 1a and 1b except that FIGS. 1c and 1d illustrate the invention during rapid fluid flow increase. In the event of a rapid fluid flow increase the fluid rapidly flows into fluid tubular 2 through the apertures intake/outflow port 1 and enters into anterior chamber 3. At this time the increase in fluid flow acts to motivate fluid plug 4 in such a manner as to wedge fluid plug 4 into chamber wall or fluid barrier 6 orifice or fluid control orifice or aperture 5 thereby partially impeding the flow of fluid through the fluid tubular 2 via anterior chamber 3. The viscosity and specific gravity of fluid material coupled with the actual flow rate motivate the fluid plug 4. If the fluid flow rate is not sufficiently retarded by the fluid plug 4 and the fluid flow rate is still significantly above the predetermined rate then the fluid plugs 4a will be actuated and wedge into the orifices 5a, therein further impeding the flow of fluid. Once the plugs 4 and/or 4a are wedged into chamber wall or fluid barrier 6 fluid control orifice or aperture 5 and/or 5a, fluid 41 still flows into posterior chamber 7 via calibrated thru flow port 8 at a greatly reduced rate and then out of fluid input/output port 9. In the case of only partial fluid flow impediment, the fluid still flows through the fluid control orifice or aperture 5 and/or 5a but at a reduced flow rate. When the rapid fluid flow event subsides, the fluid plugs 4 and/or 4a will disengage from the fluid control orifices or apertures 5 and/or 5a and regular fluid flow will resume.

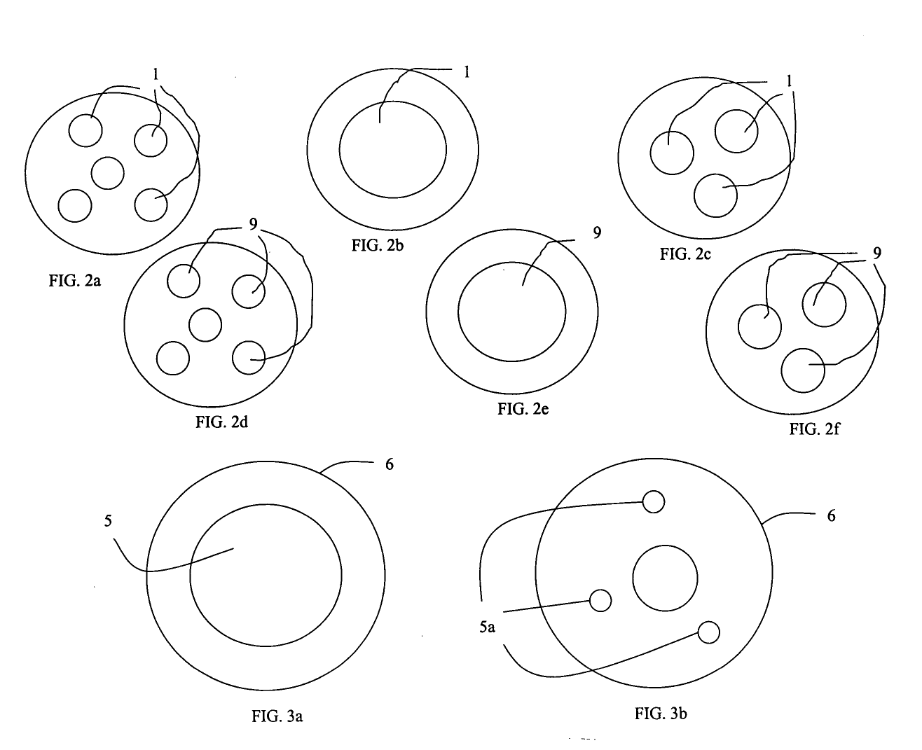

FIGS. 2a-2f illustrate several possible aperture configurations for fluid flow intake/outflow ports 1 and 9, but are not limited in scope to the aperture combinations available or potentially utilized in the present invention. Fluid intake/outflow port 1 (FIG. 2b) illustrates the use of only one fluid flow aperture for fluid flow intake/outflow port 1. Fluid intake/outflow port 9 (FIG. 2e) illustrates the use of only one fluid flow aperture for fluid flow intake/outflow port 9. Fluid intake/outflow ports 1 (FIGS. 2a and 2c) illustrate, but are not limited to, embodiments of the fluid intake/outflow port 1 in which there are a plurality of fluid flow apertures. Fluid intake/outflow ports 9 (FIGS. 2d and 2f) illustrate, but are not limited to, embodiments of the fluid intake/outflow port 9 in which there are a plurality of fluid flow apertures.

FIGS. 3a and 3b illustrate several possible fluid control orifice or aperture 5 configurations on chamber wall or fluid barrier 6. In FIG. 3a there is a chamber wall or fluid barrier 6 with one fluid control orifice or aperture 5. FIG. 3b illustrates one, but is not limited to, a chamber wall or fluid barrier 6 with a plurality of apertures. FIG. 3b specifically illustrates, but is not limited to, a chamber wall or fluid barrier 6 embodiment with one central fluid control orifice or aperture 5 and several smaller apertures 5a structured in varying positions around the chamber wall or fluid barrier 6. Apertures 5 and 5a can vary in size and shape such that variant sizes and shapes of fluid plugs 4 and 4a can releasably insert into the fluid control apertures or orifices 5 and 5a, respectively, upon activation and impede fluid flow completely or only partially pending on the severity of the event causing activation of the fluid plug 4.

FIG. 4 is substantially similar to FIG. 1a except that, in FIG. 4 threadable adapter 10 is sealably threaded into fluid containment defining wall 13. On the exterior of fluid containment defining wall 13 adjacent to the threadable adapter 10 is a valve 16. Valve 16 may include, but is not limited to a standard fluid valve, spigot, or any conventional valve used in the field or operation with the fluid utilized with the invention. The seal formed between fluid containment defining wall 13, threadable adapter 10 and valve 16 is sufficiently enabled such that no fluid 41 can leak out of interior 14 of fluid containment vessel 40. The invention operates in substantially the same manner as FIG. 1a, except that fluid flowing out of fluid tubular 2 via fluid intake/outflow port 9 comes from the fluid contained in the interior 14 of fluid containment vessel 40 and exits the interior 14 via valve 16. Likewise, interior 14 of fluid containment vessel 40 can be refilled with fluid by pumping fluid into valve 16 which then flows through intake/outflow port 9 via threadable adapter 10. It is important to note that fluid input via valve 16 and then through intake/outflow port 9 is not impeded by fluid plug 4.

FIG. 5 shows one embodiment of the present invention in which two fluid tubulars 52 are attached in series. It is important to note that any number of fluid tubulars 52 may be attached in series. The individual fluid tubulars 52 in the embodiment of FIG. 5 are substantially similar to those of FIG. 1a-1d with the following exceptions. The fluid tubulars 52 in FIG. 5 preferably do not possess calibrated thru flow port 8 which is found on the embodiment of the invention as disclosed in FIG. 1. The threadable adapters 60 of the invention in FIG. 5 are threaded such that they form a connectable seal with the female portions 62 of fluid tubulars 52. Both anterior chambers 53 and posterior chambers 57 are enclosed such that there is no fluid interaction with either anterior chamber 53 or posterior chamber 57 and the external environment. Fluid intake/outflow port 1 can be designed, optionally, (not shown) to have a fluid orifice such that when fluid flowing from posterior chamber 57 to chamber 53 and then through fluid intake/outflow port 1 exceeds a certain flow rate that fluid plug 54 is activated to wedge into fluid orifice and thereby impede fluid flow. The viscosity and specific gravity of flow material coupled with the actual flow rate motivate the fluid plug 54. FIG. 5 also discloses fluid intake/outflow port 20 (optional) which can be utilized to input or extract fluids into posterior chamber 57 as desired, such as but not limited to use in an oil pipeline. Fluids can also be pumped in the reverse manner to the above description in that fluids are pumped into the tubular 52 via port 59 such that the fluid then enters into posterior chamber 57, fluid control orifice or aperture 55 and then into anterior chamber 53. The fluid will then flow through intake/outflow port 51 through intake/outflow port 59 and into either a second posterior chamber 57 or through fluid port 19 and into fluid source 17 depending on the attached apparatus.

In normal operation, fluid can flow from fluid source 17, which can be but is not limited to any fluid container or fluid source utilized with a gas, fluid or plasma, through fluid port 19 and then through fluid intake/outflow port 51. The fluid that enters through fluid intake/outflow port 51 is housed in anterior chamber 53 where it then flows through the fluid control orifice or aperture 55 in chamber wall or fluid barrier 56 and into posterior chamber 57. The fluid will then flow from fluid chamber 57 through fluid inflow/outflow port 59 and through a second intake/outflow port 51 on an adjacent fluid tubular 52. Adjacent fluid tubulars 52 can be attached as needed via threadable adapter 60 and female portions 62. If the fluid flow rate from the fluid source 17 exceeds the calibrated flow rate for the fluid tubular 52 then fluid plug 54 is activated thereby substantially impeding fluid flow through fluid control orifice or aperture 55.

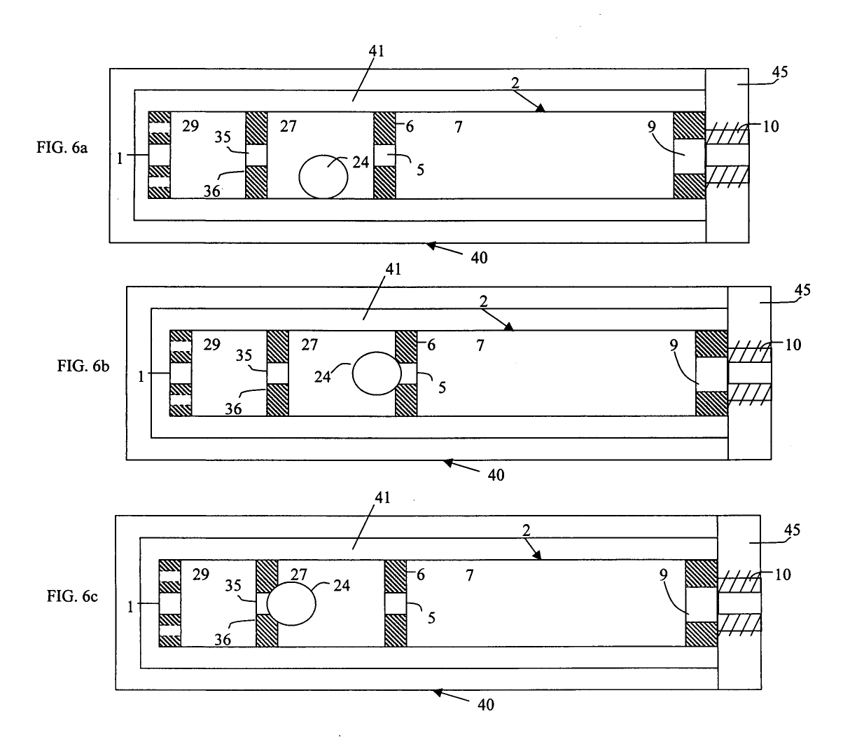

FIG. 6a shows one embodiment of the present invention, which is substantially similar to FIG. 1a except that FIG. 6a shows an embodiment of the invention with three chambers, 29, 27 and 7. Chamber 27 contains a fluid plug 24. Anterior chamber 29 is substantially similar to anterior chamber 3 of FIG. 1a, except it has no fluid plug 4. Adjacent to anterior chamber 29 is a medial chamber 27 which is preferably defined by the interior of fluid tubular 2, chamber wall or fluid barrier 6 and fluid barrier 36. The medial chamber 27 houses the fluid plug 24, which may be, but is not limited to any polyhexagonal or spheroidal shape. Medial chamber 27 is preferably semi-enclosed except for apertures 5 and 35 to allow for fluid inflow or outflow. Fluid input/outflow port 1 may be but is not limited to any fluid input/outflow port such as, but not limited to a screen. Fluid plug 24 is non-chemically reactive and non-corrosive relative to the fluid tubular 2 and the fluid flowing through fluid tubular 2. Fluid plug 24 may be one unit or a plurality of units of any polyhexagonal or spheroidal shape. Fluid plug 24 is also calibrated for both density and size, such that fluid plug 27 is mobilized upon sufficient fluid flow rate increase within fluid tubular 2.

FIGS. 6b and 6c are substantially similar to FIG. 6a except that FIGS. 6b and 6c illustrate the invention during rapid fluid flow increase. In the event of a rapid fluid flow increase as illustrated by FIG. 6b the fluid rapidly flows into fluid tubular 2 through the apertures intake/outflow port 1 and enters into anterior chamber 29. If the fluid flow exceeds the maximum threshold calibration then the fluid plug 24 is actuated in such a manner as to wedge into fluid control orifice or aperture 5 thereby impeding, either fully or partially the flow of fluid through the fluid tubular 2 via anterior chamber 29. The viscosity and specific gravity of flow material coupled with the actual flow rate activates the flow plug 24. In the case of only partial fluid flow impediment, the fluid still flows through the fluid control orifice or aperture 5 but at a reduced flow rate. When the rapid fluid decreases to a below threshold level, the fluid plug 24 will disengage from the fluid control orifices or aperture 5 and regular fluid flow will resume.

In the event of a rapid fluid flow increase as illustrated by FIG. 6c the fluid rapidly flows into fluid tubular 2 through the apertures outflow port 9 and enters into posterior chamber 7 and then into medial chamber 27. An example of this could be when fluid 41 is loaded into fluid chamber 40. At this time the increase in fluid flow acts to motivate fluid plug 24 in such a manner as to wedge fluid plug 24 into fluid control orifice or aperture 35 thereby impeding, either fully or partially the flow of fluid through the fluid tubular 2 via medial chamber 27. In the case of only partial fluid flow impediment, the fluid still flows through the fluid control orifice or aperture 35 but at a reduced flow rate. When the rapid fluid decreases to a below threshold level, the fluid plug 24 will disengage from the fluid control orifices or aperture 35 and regular fluid flow will resume.

It is noted that the fluid plugs 4, 4a, and 24, the chamber wall or fluid barriers 6 and 36 and the various fluid control orifices or apertures 5, 5a and 35 are all predetermined and synchronized to activate and deactivate upon specific fluid flow parameters. Fluid 41 flow rates can be altered by bleeding out of excess fluid via the fluid port 8, such as illustrated in FIGS. 1 and 4, at a reduced rate, capping or limiting fluid flow out of fluid outflow port 9 and threaded adapter 10, or by a variety of other methods as are known in the art.

It is noted that the embodiments described herein in detail for exemplary purposes are, of course, subject to many different variations in structure, design, application and methodology. Because many varying and different embodiments may be made within the scope of the inventive concepts herein taught, and because many modifications may be made in the embodiments herein detailed in accordance with the descriptive requirements of the law, it is to be understood that the details herein are to be interpreted as illustrative and not in a limiting sense. It will be understood in view of the instant disclosure, that numerous variations on the invention are now enabled to those skilled in the art. Many of the variations reside within the scope of the present teachings. It is not intended to limit the scope of the invention to the particular forms set forth, but on the contrary it is intended to cover such alternatives, modifications, and equivalents as may be included within the spirit and scope of the teachings of the present invention. Accordingly, the invention is to be broadly construed and is to be limited only by the spirit and scope of the claims appended hereto.

I claim:

1. An apparatus for impeding the flow of fluid through a body comprising:
a fluid barrier having at least one orifice therethrough;
a hollow body having a maximum predetermined fluid flow through rate;
the hollow body having an interior and an exterior surface with the fluid barrier disposed about the interior surface,
at least one fluid plug;
wherein the hollow body contains the at least one fluid plug positioned in the interior of the hollow body;
whereby when a fluid of a specified viscosity and specific gravity is flowing through the hollow body exceeding the predetermined flow rate, said at least fluid plug is moved and wedged into said at least one orifice in said fluid barrier thereby impeding the flow of the fluid through the body.

2. The apparatus of claim 1, wherein
the hollow body has a predetermined fluid port,
whereby fluid can enter the body at a flow rate less than said predetermined flow rate.

3. The apparatus of claim 1, wherein
the hollow body, the fluid plug, and the fluid barrier are substantially non-corrosive and non-chemically reactive with the fluid flowing through said body.

4. The apparatus of claim 1 further comprising:
said fluid barrier has a plurality of different size orifices; and
a plurality of fluid plugs, wherein
the plurality of the fluid plugs are of differing sizes,
whereby differing fluid flow rates will initiate movement of at least one of the plurality of fluid plugs to wedge into a fluid barrier orifice.

5. The apparatus of claim 1 further comprising:
said fluid barrier has a plurality of different size orifices; and
a plurality of fluid plugs, wherein
the plurality of the fluid plugs are of differing shapes,
whereby differing fluid flow rates will initiate movement of at least one of the plurality of fluid plugs to wedge into a fluid barrier orifice.

6. The apparatus of claim 1 further comprising:
said fluid barrier has a plurality of different size orifices; and
a plurality of fluid plugs, wherein
the plurality of the fluid plugs are of differing densities,
whereby differing fluid flow rates will initiate movement of at least one of the plurality of fluid plugs to wedge into a fluid barrier orifice.

7. The apparatus of claim 4 wherein the fluid barrier further comprises;
at least two orifices formed in the fluid barrier into which at least one of the plurality of fluid plugs can wedge when moved.

8. The apparatus of claim 5 wherein the fluid barrier further comprises;
at least two orifices formed in the fluid barrier into which at least one of the plurality of fluid plugs can wedge when moved.

9. The apparatus of claim 6 wherein the fluid barrier further comprises;
at least two orifices formed in the fluid barrier into which at least one of the plurality of fluid plugs can wedge when moved.

10. The apparatus of claim 1 further comprising;
a fluid container; wherein
said hollow body is attached to the interior of the fluid container.

11. The apparatus of claim 1 further comprising;
said hollow body comprises a first body and second body threadably attached to each other.

12. The apparatus of claim 1, whereby;
the fluid plug has any spheroid or polyhedral shape.

13. The apparatus of claim 1, whereby,
the body further comprises multiple fluid ports for fluid movement.

14. A method for impeding the flow of fluid through a tubular comprising;
moving a fluid through a body, wherein
the body contains an interior and an exterior; at least one fluid plug in the interior of the body; and the body contains a fluid barrier with an orifice disposed about the interior circumference of the interior,
whereby when the fluid is moving through the body at a flow rate in excess of a predetermined flow rate, the at least one fluid plug is moved and wedged into the fluid barrier orifice disposed about the interior surface thereby impeding the flow of the fluid through the body.

15. The method of claim 14, wherein
positioning a port in the body, and
moving fluid into the body via the port at a maximum predetermined flow rate.

16. The method of claim 14, wherein
constructing the body, the fluid plug, and the fluid barrier of substantially non-corrosive and non-chemically reactive material with regard to the fluid.

17. The method of claim 14 further comprising;
positioning a plurality of fluid plugs of differing sizes in the body;
moving fluid into the body;
whereby differing fluid flow rates will initiate movement of at least one of the plurality of fluid plugs to wedge into the fluid barrier orifice.

18. The method of claim 14 further comprising;
positioning a plurality of fluid plugs of differing shapes in the body;
moving fluid into the body;
whereby differing fluid flow rates will initiate movement of at least one of the plurality of fluid plugs to wedge into the fluid barrier orifice.

19. The method of claim 14 further comprising;
positioning a plurality of fluid plugs of differing densities in the body;
moving fluid into the body;
whereby differing fluid flow rates will initiate movement of at least one of the plurality of fluid plugs to wedge into the fluid barrier orifice.

20. The method of claim 17 further comprising;
positioning at least two orifices defined by the fluid barrier in the body whereby moving at least one of the plurality of fluid plugs to wedge into at least one of the two orifices.

21. The method of claim 18 further comprising;
positioning at least two orifices defined by the fluid barrier in the body, thereby allowing at least one of the plurality of fluid plugs to wedge into at least one of the two orifices.

22. The method of claim 19 further comprising;
positioning at least two orifices defined by the fluid barrier in the body, thereby allowing at least one of the plurality of fluid plugs to wedge into at least one of the two orifices.

23. The method of claim 14 further comprising;
attaching the body inside a fluid container, whereby
a fluid can be removed from, or added into the fluid container.

24. The method of claim 14 wherein;
threadably attaching a first body to a second body; and
moving fluid through the first body and the second body.

25. The method of claim 14 further comprising;
shaping the fluid plug in a spheroid or polyhedral shape.
